(19) United States
(12) Patent Application Publication
(10) Pub. No.: US 2006/0204900 A1
(43) Pub. Date: Sep. 14, 2006

(54) GREEN SHEET, PLASMA DISPLAY PANEL (PDP) AND MANUFACTURING METHOD OF PDP

(75) Inventor: Dae Hyun PARK, Yongin-si, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/276,574

(22) Filed: Mar. 6, 2006

(30) Foreign Application Priority Data
Mar. 8, 2005 (KR) 1020050019384

(51) Int. Cl. H01J 9/227

(52) U.S. Cl. 430/321; 430/319; 430/272.1; 430/270.1; 313/485

(57) ABSTRACT

The present invention relates to a green sheet, a plasma display panel (PDP) and a method of manufacturing a PDP. A black matrix or an electrode is formed using different adhesive forces of a green sheet exposed to light. Accordingly, the number of manufacturing processes can be reduced, and the manufacturing processes can be managed easily.

This non-provisional application claims priority under 35 U.S.C. § 119(a) on Patent Application No. 10-2005-0019384 filed in Korea on Mar. 8, 2005 the entire contents of which are hereby incorporated by reference.

### BACKGROUND OF THE INVENTION

1. Field of the Invention

The present invention relates to a green sheet, a plasma display panel (PDP) and a method of manufacturing a PDP.

2. Description of the Background Art

FIG. 1 is a diagram illustrating a structure of a conventional PDP. As illustrated, the PDP comprises a front panel 100 and a rear panel 110. The front panel 100 and the rear panel 110 comprise a front substrate 101 and a rear substrate 111, respectively. The front panel 100 and the rear panel 110 are joined together with a certain distance therebetween.

A pair of sustain electrodes 102 and 103 are formed on the front substrate 101 to sustain luminousness of cells by reciprocal discharges. The pair of sustain electrodes 102 and 103 comprise a scan electrode 102 and a sustain electrode 103. The scan electrode 102 and the sustain electrode 103 comprise transparent electrodes 102-a and 103-a, bus electrodes 102-b and 103-b and black electrodes 102-c and 103-c, respectively. The bus electrodes 102-b and 103-b are formed of a metal based material.

For instance, silver (Ag) is used to form the bus electrodes 102-b and 103-b. However, silver cannot transmit light emitted by a discharge, but reflects light impinging from outside. Thus, contrast of a PDP generally becomes deteriorated. The black electrode 102-c of the scan electrode 102 is formed between the transparent electrode 102-a of the scan electrode 102 and the bus electrode 102-b of the scan electrode 102 to prevent the contrast deterioration event in PDP. The same arrangement is applied to the black electrode 103-c of the sustain electrode 103 to obtain the same effect.

The scan electrode 102 receives a scan pulse for scanning and a sustain pulse for sustaining a discharge. The sustain electrode 103 receives the sustain pulse mainly. An upper dielectric layer 104 is formed on the pair of sustain electrodes 102 and 103, and limits discharge current with insulation between the electrodes. A protection layer 105 is formed on the upper dielectric layer 104, and is formed of magnesium oxide (MgO) to make a discharge event occur easily.

Address electrodes 113 are formed on the rear substrate 111 such that the address electrodes 113 cross the pair of sustain electrodes 102 and 103. A lower dielectric layer 115 is formed on the address electrodes 113 and provides insulation between the address electrodes 113. Barrier ribs 112 are formed on the lower dielectric layer 115 and forms discharge cells. A phosphor layer 114 is overlaid between the barrier ribs 112 and emits visible light to represent an image.

FIGS. 2a through 2f are cross-sectional views illustrating a method of manufacturing a conventional PDP. Herein, the same reference numerals denote the same elements described in FIG. 1.

Referring to FIG. 2a, transparent electrodes 102-a and 103-a are formed on a front substrate 101. A printed black paste BP for forming a black electrode is dried at approximately 120° C. As for a method of printing the black paste BP, the photosensitive black paste BP is placed on top of a screen mask and squeezed by a squeezer to pass through an opening of the screen mask and thus, being formed on the front substrate 101.

Referring to FIG. 2b, an electrode material EM for forming a bus electrode is printed on the black paste BP and dried thereafter.

Referring to FIG. 2c, the electrode material EM is exposed to ultraviolet (UV) light using a photo-mask 30 at which a bus electrode pattern is formed.

Referring to FIG. 2d, except for those portions of the electrode material EM hardened by the exposure to the UV light, the rest portions thereof are developed by an etch solution and the hardened portions become plastic at approximately 500° C. or higher. After this plasticity process, black electrodes 102-c and 103-c and bus electrodes 102-b and 103-b are formed.

Referring to FIG. 2e, a dielectronic paste is printed over the transparent electrodes 102-a and 103-a and the bus electrodes 102-b and 103-b and dried to form an upper dielectric layer 104.

Referring to FIG. 2f, a black matrix 106 is formed on a certain portion of the upper dielectric layer 104 corresponding to a non-discharge region between discharge cells. The black matrix 106 can be formed via a screen printing method.

Electrodes, dielectric layers or black matrixes of a conventional PDP are formed through employing a screen printing method. As the size of a PDP becomes enlarged, the size of a printing mask needs to be enlarged as well. However, the enlarged printing mask may bring out a drawback that the printing mask tends to be deformed severely as the number of printing increases. Since PDPs become increasingly enlarged, it may be difficult to implement this screen printing method to a PDP manufacturing process.

As one alternate method for the screen printing method, a green sheet technique is employed. A green sheet includes a base film, a coating layer formed on the based film and a cover film formed on the coating layer. The green sheet is laminated, exposed to light and then developed to form an intended electrode or a black matrix.

After the lamination and exposure of the green sheet to light, a wet etching process is performed in the course of developing the green sheet. During the wet etching process, a developing solution may penetrate into an interface, resulting in an edge curl event. Hence, the developing process may be managed with difficulty.

Also, since the green sheet technique needs to pass through sequential processes comprising lamination, photo-exposure and development, a PDP manufacturing process may get complicated.

### SUMMARY OF THE INVENTION

Accordingly, an object of the present invention is to solve at least the problems and disadvantages of the background art.

It is an object of the present invention to provide a green sheet and a method of manufacturing a PDP using less amount of a developing solution.

It is another object of the present invention to provide a green sheet and a method of manufacturing a PDP through a simplified process.

According to an exemplary embodiment of the present invention, a method of manufacturing a plasma display panel comprises exposing a first green sheet comprising a cover film, a black matrix dry film and a base film, to light with a first mask at which a black matrix pattern is formed, removing the cover film and laminating the first green sheet on a substrate, and removing the base film and forming a black matrix on the substrate.

According to the exemplary embodiment of the present invention, the method further comprises exposing the black matrix to light with a second mask different from the first mask, laminating a second green sheet comprising an electrode dry film and at least one release sheet, on the black matrix, and forming an electrode on the black matrix by removing the release sheet of the second green sheet.

According to another exemplary embodiment of the present invention, a green sheet for a plasma display panel comprises a base film, a black matrix dry film formed on the base film, and a cover film formed on the black matrix dry film. The black matrix dry film may comprise 10 wt % to 50 wt % of a polymer based on the total weight of the black matrix dry film, 5 wt % to 40 wt % of a photosensitive monomer based on the total weight of the black matrix dry film, 4 wt % to 15 wt % of a photopolymer initiator based on the total weight of the black matrix dry film, 10 wt % to 20 wt % of cobalt oxide based on the total weight of the black matrix dry film and 15 wt % to 25 wt % of a glass frit based on the total weight of the black matrix dry film.

According to still another exemplary embodiment of the present invention, a green sheet for a plasma display panel comprises a base film, an electrode dry film formed on the base film, and a cover film formed on the electrode dry film. The electrode dry film may comprise 81 wt % to 85 wt % of a conductive material based on the total weight of the electrode dry film, 5 wt % to 15 wt % of a glass frit based on the total weight of the electrode dry film, 0.1 wt % to 3 wt % of a dispersant based on the total weight of the electrode dry film and 1 wt % to 7 wt % of a binder based on the total weight of the electrode dry film.

According to a further exemplary embodiment of the present invention, a plasma display panel comprises a substrate, a transparent electrode formed on the substrate, a black matrix formed on the transparent electrode with a first green sheet, and a bus electrode formed on the black matrix, and of which an edge is substantially identified with the edge of the black matrix.

According to the exemplary embodiments of the present invention, a PDP and a green sheet can be manufactured without using a developing solution. Thus, a PDP manufacturing process can be managed easily.

According to the exemplary embodiments of the present invention, a PDP and a green sheet can be manufactured through the decreased number of manufacturing processes.

### BRIEF DESCRIPTION OF THE DRAWINGS

The invention will be described in detail with reference to the following drawings in which like numerals refer to like elements.

FIG. 1 is a perspective view illustrating a structure of a conventional PDP;

FIGS. 2a through 2f are cross-sectional views illustrating a method of manufacturing a conventional PDP;

FIGS. 3a through 3i are cross-sectional views illustrating a method of manufacturing a PDP according to the first exemplary embodiment of the present invention; and

FIGS. 4a through 4j are cross-sectional views illustrating a method of manufacturing a PDP according to the second exemplary embodiment of the present invention.

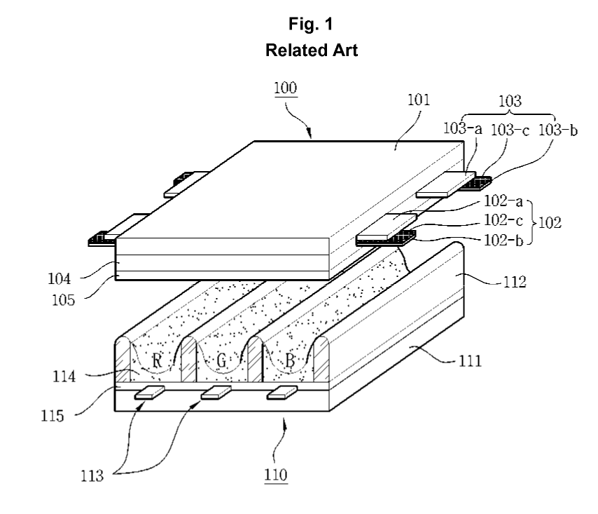

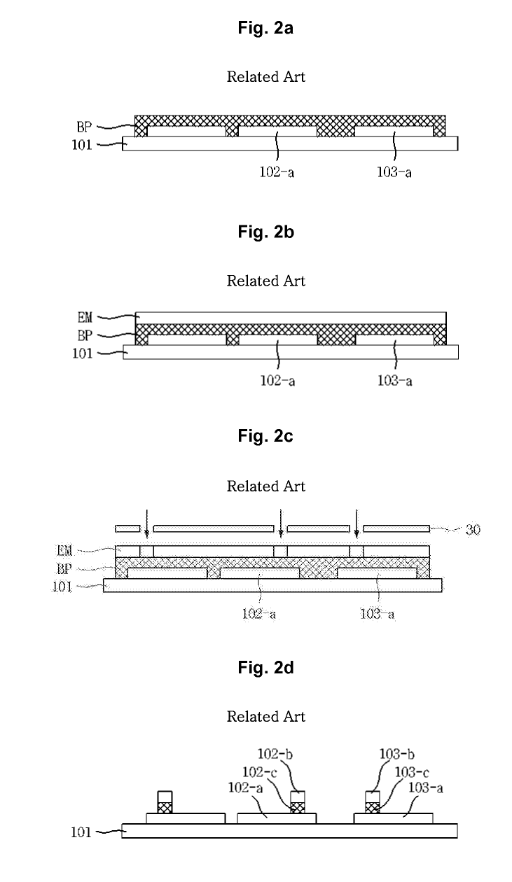

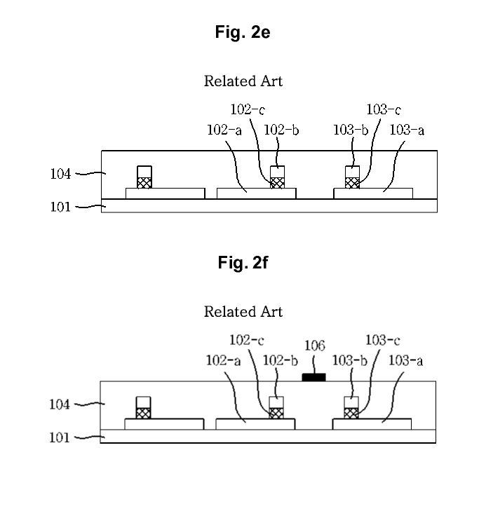

### DETAILED DESCRIPTION OF PREFERRED EMBODIMENTS

Preferred embodiments of the present invention will be described in a more detailed manner with reference to the drawings.

A PDP manufacturing method according to an exemplary embodiment comprises exposing a first green sheet comprising a cover film, a black matrix dry film and a base film, to light with a first mask at which a black matrix pattern is formed, removing the cover film and laminating the first green sheet on a substrate, and removing the base film and forming a black matrix on the substrate.

The black matrix is formed by removing the base film and a portion of the black matrix dry film exposed to the light together.

The substrate may be one of a glass substrate, a transparent electrode and a dielectric layer.

The black matrix dry film may comprises 10 wt % to 50 wt % of a polymer based on the total weight of the black matrix dry film, 5 wt % to 40 wt % of a photosensitive monomer based on the total weight of the black matrix dry film, 4 wt % to 15 wt % of a photopolymer initiator based on the total weight of the black matrix dry film, 10 wt % to 20 wt % of cobalt oxide based on the total weight of the black matrix dry film and 15 wt % to 25 wt % of a glass frit based on the total weight of the black matrix dry film.

The molecular weight may be 1000 to 100000.

The molecular weight may be 1000 to 50000.

The monomer may comprise at least one of one functional monomer, multi functional monomer or silane based monomer.

The photopolymer initiator may comprise either a benzophenone based initiator or a trizine initiator.

An adhesive force between the black matrix dry film and the cover film of the first green sheet may be less than the adhesive force between the black matrix dry film and the base film of the first green sheet, after exposing the first green sheet.

According to the exemplary embodiment of the present invention, the method may further comprise exposing the black matrix to light with a second mask having a width of a light transmittance part less than the width of the light transmittance part of the first mask, laminating a second green sheet comprising an electrode dry film and at least one release sheet, on the black matrix, and forming an electrode on the black matrix by removing the release sheet of the second green sheet.

The electrode is formed as the electrode dry film disposed on a portion of the black matrix exposed to light is removed while the release sheet is removed.

A central part of the remaining portion of the black matrix dry film may be exposed.

A plasticity of the electrode dry film may be less than the plasticity of the black matrix dry film.

The electrode dry film may comprise 81 wt % to 85 wt % of a conductive material based on the total weight of the electrode dry film, 5 wt % to 15 wt % of a glass frit based on the total weight of the electrode dry film, 0.1 wt % to 3 wt % of a dispersant based on the total weight of the electrode dry film and 1 wt % to 7 wt % of a binder based on the total weight of the electrode dry film.

The conductive material may comprise silver.

According to another exemplary embodiment of the present invention, a green sheet for a plasma display panel comprises a base film, a black matrix dry film formed on the base film, and a cover film formed on the black matrix dry film. The black matrix dry film may comprise 10 wt % to 50wt % of a polymer based on the total weight of the black matrix dry film, 5 wt % to 40 wt % of a photosensitive monomer based on the total weight of the black matrix dry film, 4 wt % to 15 wt % of a photopolymer initiator based on the total weight of the black matrix dry film, 10 wt % to 20 wt % of cobalt oxide based on the total weight of the black matrix dry film and 15 wt % to 25 wt % of a glass frit based on the total weight of the black matrix dry film.

A silicon release material may be coated on a surface of the base film contacting with the black matrix dry film and a surface of the cover film contacting with the black matrix dry film.

An amount of the silicon release material coated on the cover film may be more than the amount of the silicon release material coated on the base film.

According to still another exemplary embodiment of the present invention, a green sheet for a plasma display panel comprises a base film, an electrode dry film formed on the base film, and a cover film formed on the electrode dry film. The electrode dry film may comprise 81 wt % to 85 wt % of a conductive material based on the total weight of the electrode dry film, 5 wt % to 15 wt % of a glass frit based on the total weight of the electrode dry film, 0.1 wt % to 3 wt % of a dispersant based on the total weight of the electrode dry film and 1 wt % to 7 wt % of a binder based on the total weight of the electrode dry film.

A silicon release material may be coated on a surface of the base film contacting with the electrode dry film and a surface of the cover film contacting with the electrode dry film.

An amount of the silicon release material coated on the cover film may be more than the amount of the silicon release material coated on the base film.

The conductive material may comprise silver.

According to a further exemplary embodiment of the present invention, a plasma display panel comprises a substrate, a transparent electrode formed on the substrate, a black matrix formed on the transparent electrode with a first green sheet, and a bus electrode formed on the black matrix, and of which an edge is substantially identified with the edge of the black matrix.

Hereinafter, detailed description of the exemplary embodiments will be provided.

### FIRST EXEMPLARY EMBODIMENT

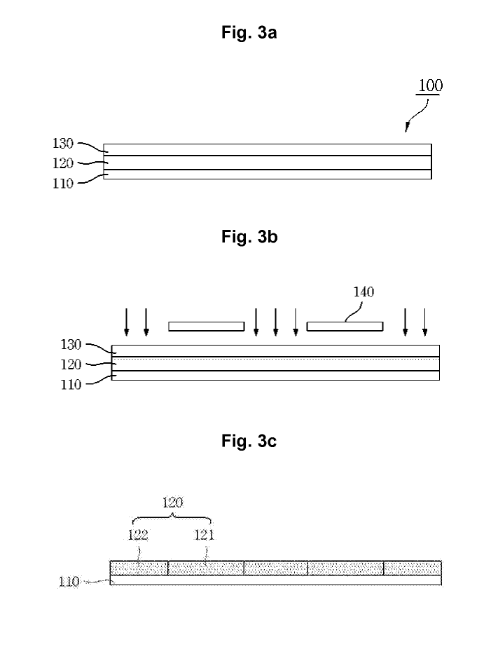

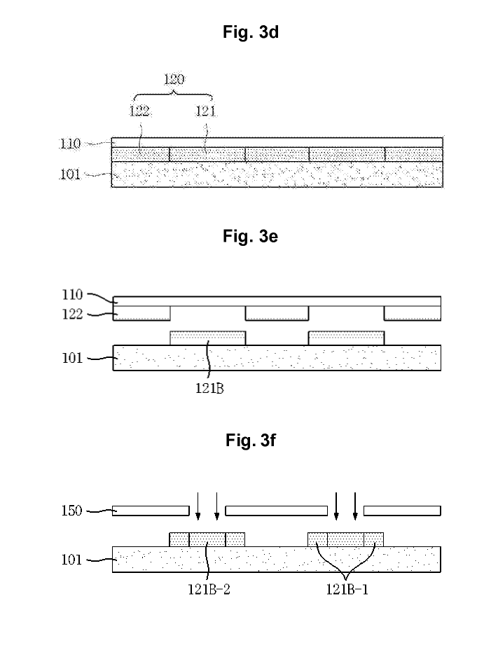

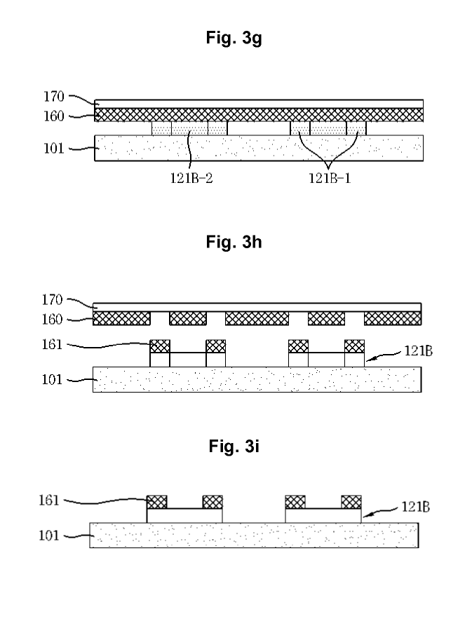

FIGS. 3a through 3i are cross-sectional views illustrating a method of manufacturing a PDP according to the first exemplary embodiment of the present invention.

Referring to FIG. 3a, a green sheet 100 is prepared. The green sheet 100 includes a base film 110, a black matrix dry film 120 formed on the base film 110 and a cover film 130 formed on the black matrix dry film 120.

A silicon release material is coated on a surface of the base film 110 contacting with the black matrix dry film 120 and on a surface of the cover film 130 contacting with the matrix dry film 120. An amount of the silicon release material coated on the cover film 130 is more than that of the silicon release material coated on the base film 110. Therefore, the cover film 130 is more easily removed from the black matrix dry film 120 than the base film 110.

The black matrix dry film 120 according to the first exemplary embodiment comprises a polymer, a photosensitive monomer, a photopolymer initiator, cobalt oxide, and a glass frit. The polymer has approximately 10 weight percent (wt %) to approximately 50 wt % based on the total weight of the black matrix dry film. The polymer has a molecular weight equal to or greater than approximately 1000 and equal to or less than approximately 100000. More specifically, the molecular weight of the polymer is equal to or greater than approximately 1000 and equal to or less than approximately 50000.

The photosensitive monomer has approximately 5 wt % to approximately 40 wt % based on the total weight of the black matrix dry film. The photosensitive monomer comprises at least one of one functional monomer, a multi functional monomer and a silane based monomer.

The photopolymer initiator has approximately 4 wt % to approximately 15 wt % based on the total weight of the black matrix dry film. The photopolymer initiator comprises a benzophenone based initiator or a trizine initiator.

The cobalt oxide has approximately 10 wt % to approximately 20 wt % based on the total weight of the black matrix dry film. The glass frit has approximately 15 wt % to approximately 25 wt % based on the total weight of the black matrix dry film.

Referring to FIG. 3b, a first mask 140 is disposed over the cover film 130, and the black matrix dry film 120 is exposed to light transmitted through the first mask 140. The first mask 140 at which a black matrix pattern is formed_defines the entire black matrix dry film 120 into non-exposure regions 121, which are not exposed to light and exposure regions 122, which are exposed to light. Because not being exposed to light, the black matrix dry film 120 of the non-exposure regions 121 maintains adhesiveness, whereas the black matrix dry film 120 of the exposure regions 122 is hardened, thereby having reduced adhesiveness.

After the completion of the exposure to the light, as illustrated in FIG. 3c, the cover film 130 is removed. The amount of the silicon release material coated on the cover film 130 is more than that of the silicon release material coated on the base film 110. Thus, an adhesive force between the cover film 130 and the black matrix dry film 120 is les than the adhesive force between the base film 110 and the black matrix dry film 120. Hence, even if the cover film 130 is removed, the black matrix dry film 120 remains adhered to the base film 110.

Interfaces of the exposure regions 122 exposed to air as the cover film 130 is removed lose adhesiveness, while another interfaces of the exposure regions 122 not being exposed to air due to the base film 110 maintain adhesiveness.

Referring to FIG. 3d, the black matrix dry film 120 is aligned with a glass substrate 101 and adhered to the glass substrate 101 via a lamination process.

Referring to FIG. 3e, when the base film 110 is removed, the black matrix dry film 120 of the non-exposure regions 121 maintaining the adhesiveness is continuously adhered to the glass substrate 101, whereas the black matrix dry film 120 of the exposure regions 122 hardened by the exposure to the light is removed from the glass substrate 101, and as a result, black matrixes 121B are formed.

That is, one surface of the exposure regions 122 exposed to air lose adhesiveness, and the other surface of the exposure regions 122 not being exposed to air due to the base film 110 have weak adhesiveness. Thus, when the base film 110 is removed, the exposure regions 122 are removed while being adhered to the base film 110. Due to the silicon release material coated on the base film 110, an adhesive force between the base film 110 and the non-exposure regions 121 is less than the adhesive force between the glass substrate 101 and the non-exposure regions 121. As a result, the non-exposure regions 121 remain on the glass substrate 101 when the base film 110 is removed.

For this reason, the black matrix dry film 120 of the exposure regions 122 is not removed by a developing process using an etch solution but by a difference in the adhesive force between the black matrix dry film 120 of the non-exposure regions 121 and the black matrix dry film 120 of the exposure regions 122. Since the black matrixes 121B are formed without employing a developing process using an etch solution, a PDP can be manufactured through the decreased number of processes. Also, a specific management of the developing process is not necessary.

Referring to FIG. 3f, a second mask 150 is disposed over the black matrixes 121B such that a central part 121B-2 of each of the black matrixes 121B is exposed to light transmitting through the second mask 150. Among the black matrixes 121B, the central parts 121B-2 are hardened by being exposed to air, thereby having a decreased adhesive force. A light transmittance part of the second mask 150 has a width smaller than the light transmittance part of the first mask 140. The light transmittance part is a region of the first mask 140 or the second mask 150 where light transmits through.

Referring to FIG. 3g, when the exposure process to the light is completed, an electrode dry film 160 of a green sheet for use in an electrode (hereinafter “electrode green sheet”) that does not include a release sheet such as a cover film is laminated on the black matrixes 121B via a lamination process. The electrode green sheet may include a base film only or a base film and a cover film. A silicon release material is coated on a surface of the base film contacting with the electrode dry film 160 and on a surface of the cover film contacting with the electrode dry film 160.

Referring to FIG. 3h, the electrode dry film 160 formed on the central parts 121B-2 of the black matrixes 121B is adhered to a release sheet 170 such as the base film and removed thereafter. Hence, the electrode dry film 160 remains selectively on both edge parts 121B-1 of the black matrixes 121B maintaining adhesiveness. Since the above process of forming the electrode dry film 160 on the black matrix dry film 120 does not proceed with a developing process using an etch solution, the number of PDP manufacturing processes can be reduced and a specific management of the developing process is not necessary.

Plasticity of the electrode dry film 160 is less than the plasticity of the black matrix 121B to make the electrode dry film 160 adhered selectively to the both edge parts 121B-1 where adhesiveness of the black matrixes 121B is maintained.

If the plasticity of the electrode dry film 160 is equal to or greater than the plasticity of the black matrix dry film 120, the electrode dry film 160 formed on the central parts 121B-2 without adhesiveness of the black matrix dry film 120 may not be removed during the removal of the base film 170.

The electrode dry film 160 comprises a conductive material, a glass frit, a dispersant, and a binder to give a different level of plasticity. The conductive material has approximately 81 wt % to approximately 85 wt % based on the total weight of the electrode dry film. The glass frit has approximately 5 wt % to approximately 15 wt % based on the total weight of the electrode dry film. The dispersant has approximately 0.1 wt % to approximately 3 wt % based on the total weight of the electrode dry film. The binder has approximately 1 wt % to approximately 7 wt % based on the total weight of the electrode dry film.

Referring to FIG. 3i, a plasticity process is performed on the above resultant structure.

### SECOND EXEMPLARY EMBODIMENT

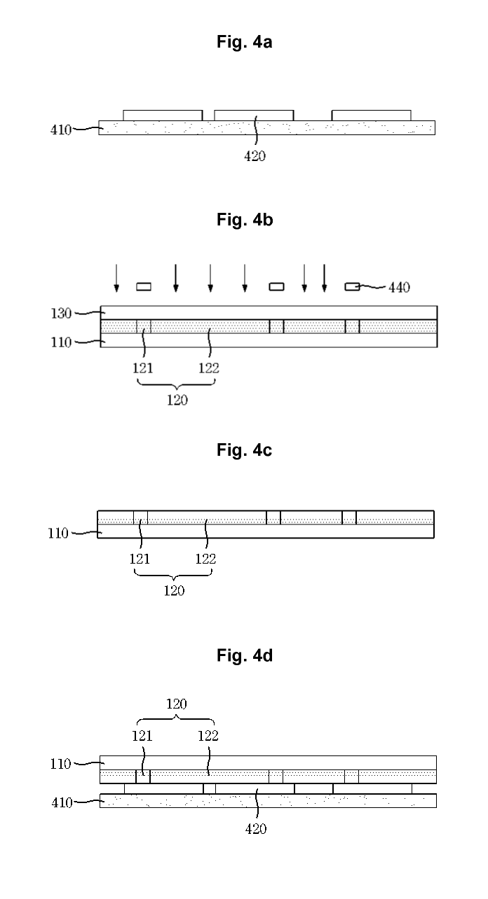

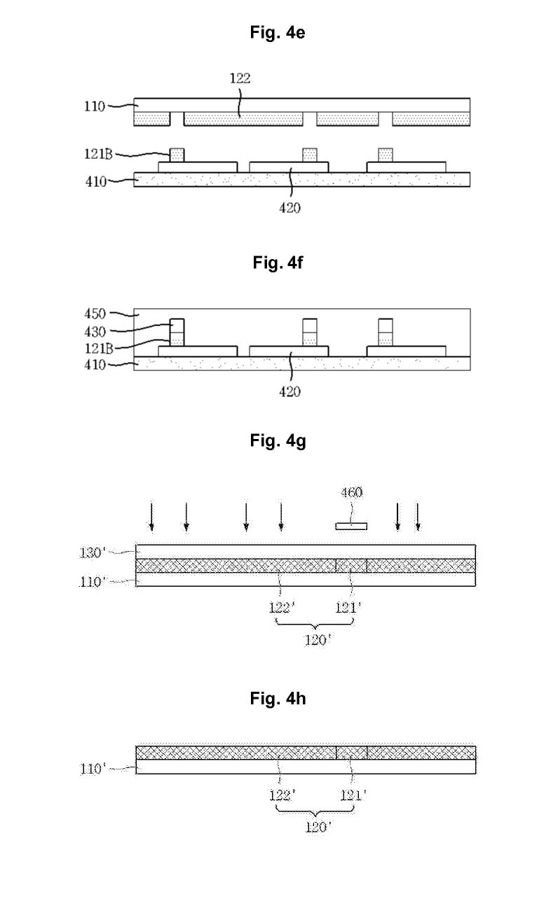

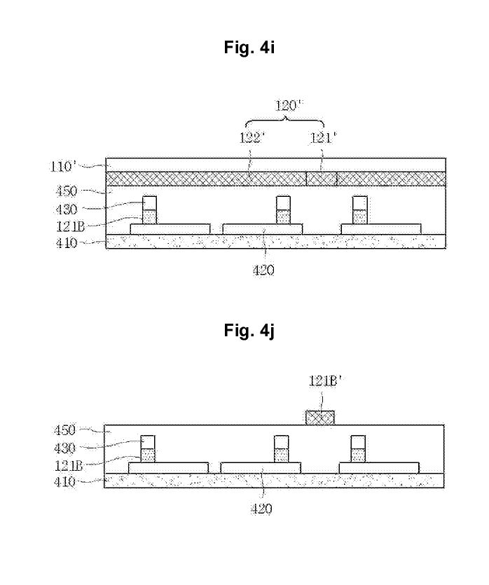

FIGS. 4a through 4g are cross-sectional views illustrating a method of manufacturing a PDP according to the second exemplary embodiment of the present invention.

Referring to FIG. 4a, a front substrate 410 on which transparent electrodes 420 are formed, and a green sheet for use in a black matrix are prepared.

Referring to FIG. 4b, a first mask 440 is disposed over a first cover film 130, and a first black matrix 120 is exposed to light transmitting through the first mask 440. Hence, the first black matrix 120 is defined into first non-exposure regions 121 not being exposed to the light and first exposure regions 122 exposed to the light. The first black matrix dry film 120 of the first non-exposure regions 121 maintains adhesiveness since the first black matrix dry film 120 of the first non-exposure regions 121 is not exposed to the light. On the contrary, the first black matrix dry film 120 of the first exposure regions 122 is hardened and thus, having a decreased adhesive force. The first black matrix dry film 120 according to the second exemplary embodiment has substantially the same composition and composition ratio to the black matrix dry film according to the first exemplary embodiment. Thus, detailed description thereof will be omitted.

Referring to FIG. 4c, after the exposure to the light, the first cover film 130 is removed. The reason for the complete removal of the first cover film 130 from the first black matrix dry film 120 is substantially identical to the reason described in FIG. 3c and in the first exemplary embodiment, and thus, detailed description thereof will be omitted.

Referring to FIG. 4d, the first black matrix dry film 120 is adhered to the transparent electrodes 420 via a lamination process.

Referring to FIG. 4e, the first black matrix dry film 120 of the first non-exposure regions 121 maintaining adhesiveness during the removal of the first base film 110 remains adhered to the transparent electrodes 420. On the other hand, the first black matrix dry film 120 of the first exposure regions 122 hardened by being exposed to the light is removed from the transparent electrodes 420. As a result of this selective removal, first black matrixes 121B are formed. The first base film 110 and the first black matrix dry film 120 of the first exposure regions 122 are removed based on substantially the same reason described in the first exemplary embodiment. Hence, detailed description thereof will be omitted.

Since the first black matrixes 121B are formed without performing a developing process using an etch solution, the number of PDP manufacturing processes can be decreased, and a specific management of the developing process is not necessary.

Referring to FIG. 4f, bus electrodes 430 are formed on the first black matrixes 121B, and then a dielectric layer 450 is formed over the entire surface of the above resultant structure. Similar to the first exemplary embodiment, the bus electrodes 430 can be formed using an electrode green sheet.

Referring to FIG. 4g, a second mask 460 is disposed over a second cover film 130′, and a second black matrix dry film 120′ is exposed to light transmitting through the second mask 460. As a result, the second black matrix 120′ is defined into second non-exposure regions 121′ not being exposed to the light and second exposure regions 122′ exposed to the light. The second black matrix dry film 120′ of the second non-exposure regions 121′ maintains adhesiveness since the second black matrix dry film 120′ of the second non-exposure regions 121′ is not exposed to the light. On the contrary, the second black matrix dry film 120′ of the second exposure regions 122′ is hardened and thus, an adhesive force thereof becomes reduced. The second black matrix dry film 120′ according to the second exemplary embodiment has substantially the same composition and composition ratio to the black matrix dry film according to the first exemplary embodiment. Thus, detailed description thereof will be omitted.

Referring to FIG. 4h, the second cover film 130′ is removed. The reason for the complete removal of the second cover film 130′ from the second black matrix dry film 120′ is substantially identical to the reason described in FIG. 3c and in the first exemplary embodiment, and thus, detailed description thereof will be omitted.

Referring to FIG. 4i, the second black matrix dry film 120′ is aligned with the dielectric layer 450 and adhered to the dielectric layer 450 via a lamination process.

Referring to FIG. 4j, the second black matrix dry film 120′ of the second non-exposure regions 121′ maintaining adhesiveness during the removal of the second base film 110′ remains adhered to the dielectric layer 450. On the other hand, the second black matrix dry film 120′ of the second exposure regions 122′ hardened by being exposed to the light is removed from the dielectric layer 450. As a result of this selective removal, a second black matrix 121B′ is formed. The second base film 110′ and the second black matrix dry film 120′ of the second exposure regions 122′ are removed based on substantially the same reason described in the first exemplary embodiment. Hence, detailed description thereof will be omitted.

Since the second black matrix 121B′ can be formed without employing a developing process using an etch solution, the number of PDP manufacturing processes can be reduced. Also, a specific management of the developing process is not necessary.

Referring to FIG. 4j, the PDP manufactured using the method and the green sheet according to the second exemplary embodiment comprises the substrate 410, the transparent electrodes 420, the first black matrixes 121B and the bus electrodes 430. The transparent electrodes 420 are formed on the substrate 410, and the first black matrixes 121B are formed on the transparent electrodes 420 using the green sheet for forming the black matrix according to the exemplary embodiments. The bus electrodes 430 are formed on the first black matrixes 121B and coincide with the edges of the first black matrixes 121B. Also, the bus electrodes 430 can be formed using the electrode green sheet according to the first exemplary embodiment.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of manufacturing a plasma display panel, steps comprising:
exposing a first green sheet comprising a cover film, a black matrix dry film and a base film, to light with a first mask at which a black matrix pattern is formed;
removing the cover film and laminating the first green sheet on a substrate; and
removing the base film and forming a black matrix on the substrate.

2. The method of claim 1, wherein the black matrix is formed by removing the base film and a portion of the black matrix dry film exposed to the light together.

3. The method of claim 1, wherein the substrate is one of a glass substrate, a transparent electrode and a dielectric layer.

4. The method of claim 1, wherein the black matrix dry film comprises 10 wt % to 50 wt % of a polymer based on the total weight of the black matrix dry film, 5 wt % to 40 wt % of a photosensitive monomer based on the total weight of the black matrix dry film, 4 wt % to 15 wt % of a photopolymer initiator based on the total weight of the black matrix dry film, 10 wt % to 20 wt % of cobalt oxide based on the total weight of the black matrix dry film and 15 wt % to 25 wt % of a glass frit based on the total weight of the black matrix dry film.

5. The method of claim 4, wherein the molecular weight is 1000 to 100000.

6. The method of claim 4, wherein the molecular weight is 1000 to 50000.

7. The method of claim 4, wherein the monomer comprises at least one of one functional monomer, multi functional monomer or silane based monomer.

8. The method of claim 4, wherein the photopolymer initiator comprises either a benzophenone based initiator or a trizine initiator.

9. The method of claim 1, wherein an adhesive force between the black matrix dry film and the cover film of the first green sheet is less than the adhesive force between the black matrix dry film and the base film of the first green sheet, after exposing the first green sheet.

10. The method of claim 1, further comprising exposing the black matrix to light with a second mask having a width of a light transmittance part less than the width of the light transmittance part of the first mask,
laminating a second green sheet comprising an electrode dry film and at least one release sheet, on the black matrix, and
forming an electrode on the black matrix by removing the release sheet of the second green sheet.

11. The method of claim 10, wherein the electrode is formed as the electrode dry film disposed on a portion of the black matrix exposed to light is removed while the release sheet is removed.

12. The method of claim 10, wherein a central part of the remaining portion of the black matrix dry film is exposed.

13. The method of claim 10, wherein a plasticity of the electrode dry film is less than the plasticity of the black matrix dry film.

14. The method of claim 10, wherein the electrode dry film comprises 81 wt % to 85 wt % of a conductive material based on the total weight of the electrode dry film, 5 wt % to 15 wt % of a glass frit based on the total weight of the electrode dry film, 0.1 wt % to 3 wt % of a dispersant based on the total weight of the electrode dry film and 1 wt % to 7 wt % of a binder based on the total weight of the electrode dry film.

15. The method of claim 14, wherein the conductive material comprises silver.

16. A green sheet for a plasma display panel comprising:
a base film;
a black matrix dry film formed on the base film; and
a cover film formed on the black matrix dry film,
wherein the black matrix dry film comprises 10 wt % to 50 wt % of a polymer based on the total weight of the black matrix dry film, 5 wt % to 40 wt % of a photosensitive monomer based on the total weight of the black matrix dry film, 4 wt % to 15 wt % of a photopolymer initiator based on the total weight of the black matrix dry film, 10 wt % to 20 wt % of cobalt oxide based on the total weight of the black matrix dry film and 15 wt % to 25 wt % of a glass frit based on the total weight of the black matrix dry film.

17. The green sheet of claim 16, wherein a silicon release material is coated on a surface of the base film contacting with the black matrix dry film and a surface of the cover film contacting with the black matrix dry film.

18. The green sheet of claim 17, wherein an amount of the silicon release material coated on the cover film is more than the amount of the silicon release material coated on the base film.

19. A green sheet for a plasma display panel comprising:
a base film;
an electrode dry film formed on the base film; and
a cover film formed on the electrode dry film,
wherein the electrode dry film comprises 81 wt % to 85 wt % of a conductive material based on the total weight of the electrode dry film, 5 wt % to 15 wt % of a glass frit based on the total weight of the electrode dry film, 0.1 wt % to 3 wt % of a dispersant based on the total weight of the electrode dry film and 1 wt % to 7 wt % of a binder based on the total weight of the electrode dry film.

20. The green sheet of claim 19, wherein a silicon release material is coated on a surface of the base film contacting with the electrode dry film and a surface of the cover film contacting with the electrode dry film.

21. The green sheet of claim 20, wherein an amount of the silicon release material coated on the cover film is more than the amount of the silicon release material coated on the base film.

22. The green sheet of claim 19, wherein the conductive material comprises silver.

23. A plasma display panel comprising:
a substrate;
a transparent electrode formed on the substrate;
a black matrix formed on the transparent electrode with a first green sheet; and
a bus electrode formed on the black matrix, and of which an edge is substantially identified with the edge of the black matrix,

24. The plasma display panel of claim 23, wherein the first green sheet comprises a black matrix dry film, and
wherein the black matrix dry film comprises 10 wt % to 50 wt % of a polymer based on the total weight of the black matrix dry film, 5 wt % to 40 wt % of a photosensitive monomer based on the total weight of the black matrix dry film, 4 wt % to 15 wt % of a photopolymer initiator based on the total weight of the black matrix dry film, 10 wt % to 20 wt % of cobalt oxide based on the total weight of the black matrix dry film and 15 wt % to 25 wt % of a glass frit based on the total weight of the black matrix dry film.

25. The plasma display panel of claim 23, wherein the bus electrode is formed with a second green sheet comprising an electrode dry film, and
the electrode dry film comprises 81 wt % to 85 wt % of a conductive material based on the total weight of the electrode dry film, 5 wt % to 15 wt % of a glass frit based on the total weight of the electrode dry film, 0.1 wt % to 3 wt % of a dispersant based on the total weight of the electrode dry film and 1 wt % to 7 wt % of a binder based on the total weight of the electrode dry film.

26. The plasma display panel of claim 25, wherein the conductive material comprises silver.
